(19) United States
(12) Patent Application Publication
(10) Pub. No.: US 2025/0234283 A1
(43) Pub. Date: Jul. 17, 2025

(54) MEMBER USER EQUIPMENT SELECTION FOR ARTIFICIAL INTELLIGENCE/MACHINE LEARNING

(71) Applicant: Samsung Electronics Co., Ltd., Gyeonggi-do (KR)

(72) Inventors: Tingyu XIN, Middlesex (GB); David GUTIERREZ ESTEVEZ, Middlesex (GB)

(21) Appl. No.: 19/010,651

(22) Filed: Jan. 6, 2025

(30) Foreign Application Priority Data
Jan. 12, 2024 (GB) 2400495.4
Dec. 6, 2024 (GB) 2417948.3

(51) Int. Cl. H04W 48/18; H04L 41/14; H04W 28/02

(52) U.S. Cl. CPC H04W 48/18; H04L 41/14; H04W 28/0226

(57) ABSTRACT

Disclosed is a 5G or 6G communication system for supporting a higher data transmission rate. A method for selecting one or more user equipments (UEs) for an artificial intelligence/machine learning (AI/ML) operation including an application function (AF), a network exposure function (NEF), and a network data analytics function (NWDAF), includes transmitting, from the AF to the NEF, a first message for requesting UE selection assistance and including member UE filtering criterion and a specific parameter depending on the member UE filtering criteria, transmitting, from the NEF to the NWDAF, a second message including the specific parameter depending on the member UE filtering criteria and an indication of a request for end-to-end data volume transfer time analytics, transmitting, from the NWDAF to the NEF, a third message including one or more analytics associated with end-to-end data volume transfer time, deriving, by the NEF, based on the analytics and the member UE filtering criteria, a list of one or more candidate UEs that fulfil the member UE filtering criteria; and transmitting, from the NEF to the AF, a fourth message including the list of one or more candidate UEs that fulfil the member UE filtering criteria.

### PRIORITY

This application is based on and claims priority under 35 U.S.C. § 119 to UK Patent Application Nos. 2400495.4 and 2417948.3, filed in the Intellectual Property Office of the United Kingdom on Jan. 12, 2024, and Dec. 6, 2024, respectively, the disclosures of which are incorporated herein by reference in their entireties.

### BACKGROUND

### 1. Field

The disclosure relates generally to wireless communication systems and, more particularly, to a method and apparatus for supporting member user equipment (UE) selection such as artificial intelligence (AI)/machine learning (ML) such as in a 3^{rd} generation partnership project (3GPP) 5^{th} generation (5G) new radio (NR) network.

### 2. Description of Related Art

Given the development of wireless communication, technologies have been developed mainly for services targeting humans, such as voice calls, multimedia services, and data services. Following the commercialization of 5G communication systems, it is expected that the number of connected devices will exponentially increase and will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality (AR) glasses, virtual reality headsets, and hologram devices. To provide various services by connecting hundreds of billions of devices and things in the 6th generation (6G) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bit per second (bps) and a radio latency less than 100 microseconds (μsec), and thus will be 50 times as fast as 5G communication systems and have the 1/10 radio latency thereof.

To accomplish such a high data rate and an ultra-low latency, it has been considered to implement 6G communication systems in a terahertz (THz) band (for example, 95 gigahertz (GHz) to 3 THz bands). It is expected that, due to severer path loss and atmospheric absorption in the terahertz bands than those in millimeter wave (mmWave) bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple-input multiple-output (MIMO), full dimensional MIMO (FD-MIMO), array antennas, and multiantenna transmission technologies such as large-scale antennas. In addition, there has been ongoing discussion on new technologies for improving the coverage of THz-band signals, such as metamaterial-based lenses and antennas, orbital angular momentum (OAM), and reconfigurable intelligent surface (RIS).

To improve the spectral efficiency and the overall network performances, the following technologies have been developed for 6G communication systems: a full-duplex technology for enabling an uplink transmission and a downlink transmission to simultaneously use the same frequency resource at the same time, a network technology for utilizing satellites, high-altitude platform stations (HAPS), and the like in an integrated manner, an improved network structure for supporting mobile base stations and the like and enabling network operation optimization and automation and the like, a dynamic spectrum sharing technology via collision avoidance based on a prediction of spectrum usage, an use of AI in wireless communication for improvement of overall network operation by utilizing AI from a designing phase for developing 6G and internalizing end-to-end AI support functions, and a next-generation distributed computing technology for overcoming the limit of UE computing ability through reachable super-high-performance communication and computing resources (such as mobile edge computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will enable the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

Documents that may be referenced herein may include 3GPP technical specification (TS) 22.261 (e.g. V19.5.0), 3GPP TS 23.501 (e.g. V18.4.0), 3GPP TS 23.502 (e.g. V18.4.0), 3GPP TS 23.503 (e.g. V18.4.0), and 3GPP TS 23.288 (e.g. V18.4.0).

In AI/ML operation, AI/ML models and/or data may be transferred across the AI/ML applications (AFs), 5G core (5GC) and UEs (including the AI/ML server in the UE). The AI/ML operation may be divided into model training and inference phases, during which multiple rounds of interaction may be required.

As described in 3GPP TS 22.261, certain AI/ML operation types may be categorized into three types: model splitting, model sharing, and distributed/federated learning. The requirements, frequency and/or volume of data transmission may differ for different AI/ML processing phrases and/or operation types.

In clause 6.40 of 3GPP TS 22.261, AI/ML model transfer of three types of AI/ML operations to be supported in Release 18 are described as follows:
AI/ML operation splitting between AI/ML endpoints
The AI/ML operation/model is split into multiple parts according to the current task and environment. The intention is to offload the computation-intensive, energy-intensive parts to network endpoints, whereas leave the privacy-sensitive and delay-sensitive parts at the end device. The device executes the operation/model up to a specific part/layer and then sends the intermediate data to the network endpoint. The network endpoint executes the remaining parts/layers and feeds the inference results back to the device.
AI/ML model/data distribution and sharing over 5G system
Multi-functional mobile terminals might need to switch the AI/ML model in response to task and environment variations. The condition of adaptive model selection is that the models to be selected are available for the mobile device. However, given the fact that the AI/ML models are becoming increasingly diverse, and with the limited storage resource in a UE, it can be determined to not pre-load all candidate AI/ML models on-board. Online model distribution (i.e. new model downloading) is needed, in which an AI/ML model can be distributed from a NW endpoint to the devices when they need it to adapt to the changed AI/ML tasks and environments. For this purpose, the model performance at the UE needs to be monitored constantly.
Distributed/Federated Learning over 5G system
The cloud server trains a global model by aggregating local models partially-trained by each end devices. Within each training iteration, a UE performs the training based on the model downloaded from the AI server using the local training data. Then the UE reports the interim training results to the cloud server via 5G UL channels. The server aggregates the interim training results from the UEs and updates the global model. The updated global model is then distributed back to the UEs and the UEs can perform the training for the next iteration.

This section describes certain 5GC enablers for supporting distributed/federated learning, model sharing and model operation splitting AI/ML operations in the application layer.

The application function (AF) that aims to provide an AI/ML service to UE(s) may request 5GC assistance for federated learning, splitting AI/ML operation etc. as described in clause 5.46.2 of 3GPP TS 23.501. The AF may subscribe to the network exposure function (NEF) by sending a list of target UEs, filtering criteria and other corresponding requirements for member UE selection. Based on the AF subscription information, the NEF may collect information and service data of the corresponding candidate UEs and determine the UE(s) that can fulfil the filtering criteria and any other requirements. The NEF notifies the AF of the list of candidate UE(s) that fulfil the certain filtering criteria and requirements provide by the AF, as described in clause 4.15.13 of 3GPP TS 23.502. The list of candidate UE(s) may become the UEs for this AI/ML operation depending on the AF internal policies and final decision.

During the AI/ML operation (e.g. federated learning operation), the AF may update the filtering criteria and/or list of target UE(s) to improve or maintain the service quality. This may be done for various reasons, such as if some of the UE cannot fulfil the quality of service (QOS) requirement, if some UEs move out of an area of interest resulting in there not being enough UEs to participate the AI/ML operation, if the transfer time of the UEs cannot fulfil the required thresholds, etc. Based on an updated request from the AF, the NEF may update the list of candidate UE(s), and then inform the AF about the new list of candidate UE(s) that fulfil the requirements and/or inform the AF of any UE(s) that cannot fulfil the requirements.

Alternatively, the AF may select a list of UE(s) for the AI/ML operation (e.g. distributed/federated learning) without NEF involvement, depending on operator policies, as described in (informative) Annex I of 3GPP TS 23.502.

To schedule the AI/ML traffic more efficiently and avoid 5G System (5GS) congestion, the AF that provides the AI/ML service may negotiate with 5GC on a preferred time window for the AI/ML operation (e.g. model transfer and/or inference data transfer) using the Planned Data Transfer with QoS (PDTQ) requirements described in clause 6.1.2.7 of 3GPP TS 23.503.

When the AI/ML operation starts (e.g. when, or just before, the distributed/federated learning starts), the AF discovers a suitable NEF and requests the NEF to provide the QoS for the list of UEs (such as each UE identified by its UE Internet protocol (IP) address) that were selected, as described in clause 4.15.13 of 3GPP TS 23.502. The AF may subscribe to QoS Monitoring for those AF requests for QoS that result in a successful resource allocation. The AF may provide one or more of the following, that are derived from the performance requirements listed in clause 7.10 of 3GPP TS 22.261: QOS parameters, QoS profiles, QOS requirements, corresponding 5G QoS Identifiers (5QIs), etc.

As a result of the subscription to NEF to provide the list of UEs that fulfil certain filtering criteria, the AF may be notified about changes in the list of candidate UEs. As such, the AF may request a new preferred time window for the AI/ML operation using the Planned Data Transfer with QoS, or may request to provide a QoS with an updated list of UEs. Among the updated UEs, some may not require resources allocation any longer, and some newly selected UEs may require resource allocation and QoS Monitoring.

The AF that aims to provide an AI/ML operation (e.g. model sharing) may request assistance from the 5GC, as described in clause 4.15.3.2.3 in 3GPP TS 23.502 by subscribing to the NEF to be notified on the traffic volume shared between the UE and the AI/ML application server. This may help the AI/ML application server to determine how large the model is, and then, for example, select large models less frequently than small models.

In addition, to support AI/ML operations, one or more of the following may be used:
AF requests to the 5G System in the context of 5GS assistance to AI/ML operations in the application layer shall be authorized by the 5GC using existing mechanisms (before Release 18).
User plane function (UPF) may perform traffic detection for AI/ML traffic, as defined in clause 5.8.2.4 of 3GPP TS 23.501, and the network may support charging for AI/ML traffic.
Information exposure to an authorized third party.
External parameter provisioning.
Network data analytics support.

In the 3GPP release (Rel-) 18 specification, the 5G System can support UE member selection assistance functionality to assist the AF in selecting members/member UE(s) that are able to participate in some services (e.g. the application AI/ML operations, including federated learning, split learning/inference, reinforcement learning, etc.). The member UE selection assistance functionality may be hosted by NEF. Member UE selection procedures are described in clause 4.15.13 of 3GPP TS 23.502. The features of the member UE selection assistance functionality hosted by NEF include the following:
Receiving a request from the AF that shall include a list of target member UE(s) (which may not necessarily be a part of the subsequent updated request), one or more filtering criteria, as specified in Table 4.15.13.2-1 of 3GPP TS 23.502 (e.g. UE current location, UE historical location, UE direction, UE separation distance, QoS requirements, data network name (DNN), preferred access/radio access technology (RAT) type, desired end-to-end (E2E) data volume transfer time performance, or service experience), optionally (a) time window(s), etc.
Referring to the filtering criteria provided by the AF and then interacting with 5GC Network Functions (NFs), using existing services to collect the corresponding data for the list of target member UEs from relevant 5GC NFs (e.g. policy control function (PCF), network data analytics function (NWDAF), access and mobility management function (AMF), session management function (SMF)) to derive the list of candidate UE(s) (i.e. UE(s) among the list of target member UE(s) provided by the AF) which fulfil the filtering criteria.
Providing the AF with the member UE selection assistance information, including one or more lists of candidate UE(s), and optionally other additional information (e.g. one or more recommended time window(s) for performing the application operation, QoS of each target UE, UE(s) location(s), access/RAT type, or service experience. NEF may also provide the number of UEs per each filtering criterion that do not fulfil the corresponding filtering criterion.

FIG. 1 illustrates FIG. 4.15.13.1-1 of 3GPP TS 23.502: 5GC assistance to member UE selection and update to which the disclosure is applied.

Referring to FIG. 1, In step 105, the AF subscribes the Member UE selection assistance a information by sending first Nnef_MemberUESelectionAssistance_subscribe request including a list of target member UEs, one or more member UE filtering criteria as listed in Table 4.15.13.2-1 and optionally, time window(s). Subsequently, the AF may only update the Member UE filtering criteria of the subscription as described in clause 4.15.13.0 by invoking Nnef_MemberUESelectionAssistance_subscribe and providing a Subscription Correlation ID, i.e. the AF does not provide the list of target member UEs again.

In step 110, if the AF request does not contain a Subscription Correlation ID, the NEF verifies the authorization of the AF Request and identifies which information needs to be collected for each UE in the list of target member UEs and executes the corresponding service operations based on the Member UE filtering criteria provided by the AF, e.g. events, analytics ID(s), notifications, etc.

In step 115, if the AF request contains a Subscription Correlation ID, the NEF correlates the Nnef_MemberUESelectionAssistance_Subscribe request to an existing subscription according to the Subscription Correlation ID. The NEF uses the target member UEs received in step 1 for the Member UE update using the updated filtering criteria.

In step 120, the NEF interacts with different 5GC network functions to collect the required information for each UE in the list of target member UEs. The set of interactions between the NEF and the 5GC NFs depend on the Member UE filtering criteria provided by the AF. See Table 4.15.13.2-1 for details.

In step 125, based on the collected information from other 5GC NFs, the NEF consolidates all the information to derive the list(s) of candidate UEs which fulfil the Member UE filtering criteria in the AF request. The NEF may derive recommended time window(s), considering the validity period(s) of the analytics used for Member UE selection criteria. During the recommended time window(s), the list(s) of candidate UE(s) can fulfil the Member UE filtering criteria. The recommended time window(s) are a subset of the time window(s) received from the AF. In different recommended time windows, the list of candidate UE(s) which fulfil the Member UE filtering criteria may be different.

In step 130, the NEF sends a Nnef_MemberUESelectionAssistance_Notify request to the AF including the list(s) of candidate UEs and possibly additional information. See clause 5.2.6.32.4 for details.

The NEF performs the member UE selection assistance functionality based on an AF request to determine one or more lists of UEs that fulfil and/or cannot satisfy the filtering criteria and any other requirements. The AF invokes Nnef_MemberUESelectionAssistance_Subscribe service, as detailed in clause 5.2.6.32.2 of 3GPP TS 23.502, by indicating the following parameters to NEF:
Inputs, Required: Notification Target Address (+ Notification Correlation ID), at least one filtering criteria shown in Table 4.15.13.2-1.
Inputs, Conditional Required:
If no Subscription Correlation ID is provided in the subscription, Target of Member UE Selection Assistance Reporting (GPSI or a list of GPSIs) is required.
Inputs, Optional: Application ID, Subscription Correlation ID (in the case of modification of the existing subscription), Expiry time, a set of Member UE filtering criteria shown in the Table 4.15.13.2-1 of TS 23.502, time window(s) for selecting the candidate UEs, specific parameters depending on the Member UE filtering criteria, Periodicity (the periodicity of member update), maximum number of UEs (indicates the maximum number of candidate UEs that need to be fed back).
Outputs, Required: When the subscription is accepted: Subscription Correlation ID, Expiry time (required if the subscription can be expired based on the operator's policy).

After sending the subscribe request, the AF expects certain outputs from NEF via Nnef_MemberUESelectionAssistance_Notify, in particular a list of candidate UE(s), and optionally corresponding time window(s), specific values of the parameters per candidate UE, and the number of UEs that cannot fulfil specific filtering criteria, as defined in clause 5.2.6.32.4 of 3GPP TS 23.502:
Service operation name: Nnef_MemberUESelectionAssistance_Notify
Description: NEF reports the Member UE selection assistance information to the consumer that has previously subscribed.
Inputs, Required: Notification Correlation Information.
Inputs, Conditional Required:
At least one of the following inputs is required:
   One or more list(s) of candidate UE(s).
Inputs, Optional: Recommended time window for performing the application operation per list of candidate UE(s) as described in clause 4.15.13.1, specific value of the parameters that NEF gathered for the Member UE filtering criteria per candidate UE, a number for each filtering criterion that indicates the UEs in the initial list which do not meet the criterion (provided if there are multiple filtering criteria in the subscribe request).
   NOTE: This number can be an indication for AF to revise the corresponding filtering criterion.
Outputs, Required: Operation execution result indication.

The AF may determine the UE(s) that participate the AI/ML operation and/or the operation time window considering the outputs of NEF and the AF internal logic.

The filtering criteria of member UE selection and the corresponding procedures are specified in clause 4.15.13.2 to clause 4.15.13.6 of 3GPP TS 23.502. The filtering criteria may include QoS requirements, access type or RAT type of protocol data unit (PDU) session, E2E data volume transfer time analytics, UE current and historical location, UE separation distance, service experience analytics and DNN.

If AF sends the E2E data volume transfer time analytics as one of the filtering criteria to NEF, the NEF will subscribe to, or send a request to, the NWDAF to obtain the corresponding output analytics. As specified in clause 6.18 of 3GPP TS 23.288, to assist with the AI/ML operation, based on the NEF subscription or request, the NWDAF may derive the transfer time analytics by considering the following filter information and input parameters:

The consumer of these analytics indicates in the request or subscription:
Analytics Filter Information including:
   Optionally, DNN;
   Optionally, S-NSSAI;
   Optionally, Application ID;
   Optionally, Area of Interest (AOI(s)): restricts the scope of the E2E data volume transfer time analytics to the provided area;
   Optionally, a list of analytics subsets that are requested (see clause 6.18.3);
   QoS requirements (e.g. 5Q1, QoS Characteristics);
   Optionally, either a target number of repeating data transmissions or a target time interval between data transmissions within the Analytics target period;
Data Volume UL/DL: indicates a specific data volume transmitted once from UE to AF and/or from AF to UE;
A request for geographical distribution (i.e., the AoIs) of the UEs.
An Analytics target period indicates the time period over which the statistics or predictions are requested.
In a subscription, the Notification Correlation Id and the Notification Target Address are included.
Optionally, preferred level of accuracy of the analytics.
Optionally, preferred level of accuracy per analytics subset (see clause 6.18.3).
Optionally, preferred order of results for the list of E2E data volume transfer time:
   ordering criterion: “E2E data volume transfer time”,
   order: ascending or descending.
Optionally, Reporting Thresholds, which apply only for subscriptions and indicate conditions on the levels to be reached for the respective analytics subsets (see clause 6.18.3)
Optionally, maximum number of UEs.

The data volume UL/DL and a request for geographical distribution (i.e. the AoIs) of the UEs are two new parameters added into the subscription or the request of the NWDAF consumer.

The data volume UL/DL and a request for geographical distribution (i.e. the AoIs) of the UEs are two new and mandatory parameters in the subscription or the request of the NWDAF consumer for E2E data volume transfer time analytics. In addition, QoS requirements are mandatory filter information of E2E data volume transfer time analytics. A target number of repeating data transmissions and/or a target time interval between data transmissions is needed by NWDAF to calculate an average value of every data volume transfer time within the Analytics target period.

When deploying E2E traffic volume transfer time analytics to assist the AIML operation, the NEF and/or the AF may be the consumer of NWDAF. The AF and/or NEF should inform NWDAF of certain information, such as one or more of: expected/observed/measured data volume UL/DL/roundtrip, a request for geographical distribution (e.g. the AoIs) of the UEs, a target number of repeating data transmissions, a target time interval between data transmissions, and QoS requirements (e.g. 5Q1, QoS characteristics).

However, in the current specification, it is unclear how to provide the information mentioned above in the subscription request by AF and/or NEF to NWDAF. In particular, when the NEF is the analytics consumer, the NEF may not have any previous knowledge of the above information. It is unclear how the AF can provide the above information to the NEF. It is also unclear whether it is possible for the NEF and/or NWDAF to reuse parameters associated with other UE member filtering criterion as the filter information of E2E data volume transfer time analytics.

In the current member UE selection assistance functionality, as described in clause 5.2.6.32.4 of 3GPP TS 23.502, the AF may revise the filtering criterion based on the number of UEs that cannot fulfil the filtering criterion. However, the UE and/or network conditions could vary significantly in different time windows or at different time points. In some situations, a relatively large number of UEs may not fulfil the filtering criterion, but only within a relatively low number of time windows or time points. In other time windows or at other time points, the number of UEs not fulfilling the filtering criteria may be relatively low or zero. In this case, the AF may not need to decrease the threshold and/or requirements of the filtering criterion to maintain the overall performance of the AI/ML operation, or any other types of operations/services.

However, in the current specification, the AF is unaware of the corresponding time window(s) or time point(s) associated with the number of UEs that cannot fulfil a filtering criterion.

Accordingly, there is a need in the art for an improved method and apparatus for member UE selection for AI/ML in a wireless communication system.

### SUMMARY

The disclosure has been made to address at least the above-mentioned problems and/or disadvantages and to provide at least the advantages described below.

Accordingly, an aspect of the disclosure is to provide a for supporting member UE selection for AI/ML in a 3GPP 5G NR network.

An aspect of the disclosure is to provide a method for identifying one or more UEs (e.g. performing member UE selection) for participating in an AI/ML operation (e.g. federated learning).

In accordance with an aspect of the disclosure, there is provided a method for selecting one or more user equipment (UE) for participating in an artificial intelligence/machine learning (AI/ML) operation in a wireless communication system, the wireless communication system comprising an application function (AF), a network exposure function (NEF), and a network data analytics function (NWDAF), and the method comprising: transmitting, from the AF to the NEF, a first message for requesting UE selection assistance and including member UE filtering criterion and a specific parameter depending on the member UE filtering criteria, wherein the member UE filtering criteria includes an end-to-end data volume transfer time; transmitting, from the NEF to the NWDAF, a second message including the specific parameter depending on the member UE filtering criteria and an indication of a request for end-to-end data volume transfer time analytics; transmitting, from the NWDAF to the NEF, a third message including one or more analytics associated with end-to-end data volume transfer time; deriving, by the NEF, based on the analytics and the member UE filtering criteria, a list of one or more candidate UEs that fulfil the member UE filtering criteria; and transmitting, from the NEF to the AF, a fourth message including the list of one or more candidate UEs that fulfil the member UE filtering criteria, wherein the specific parameter depending on the member UE filtering criteria includes one or more of a data volume of UL/DL data, a target number of data transmission repetitions, a target time interval between data transmissions, and a request for geographical distribution of the UEs.

In accordance with an aspect of the disclosure, there is provided a wireless communication system comprising an application function (AF), a network exposure function (NEF), and a network data analytics function (NWDAF), wherein the wireless communication system is configured to: transmit, from the AF to the NEF, a first message for requesting UE selection assistance and including member UE filtering criteria and a specific parameter depending on the member UE filtering criteria, wherein the member UE filtering criteria includes an end-to-end data volume transfer time; transmit, from the NEF to the NWDAF, a second message including the specific parameter depending on the member UE filtering criteria and an indication of a request for end-to-end data volume transfer time analytics; transmit, from the NWDAF to the NEF, a third message including one or more analytics associated with end-to-end data volume transfer time; derive, by the NEF, based on the analytics and the member UE filtering criteria, a list of one or more candidate UEs that fulfil the member UE filtering criteria; and transmit, from the NEF to the AF, a fourth message including the list of one or more candidate UEs that fulfil the member UE filtering criteria, wherein the specific parameter depending on the member UE filtering criteria includes one or more of a data volume of UL/DL data, a target number of data transmission repetitions, a target time interval between data transmissions, and a request for geographical distribution of the UEs.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates FIG. 4.15.13.1-1 of 3GPP TS 23.502]: 5GC assistance to member UE selection and update to which the disclosure is applied;

FIG. 2 illustrates a modification to FIG. 4.15.13.6.2-1 of 3GPP TS 23.502 assistance to member UE selection for end-to-end data volume transfer time related filtering criteria, according to an embodiment;

FIG. 3 illustrates a network entity, according to an embodiment;

FIG. 4 illustrates a terminal, according to an embodiment;

FIG. 5 illustrates a base station, according to an embodiment; and

FIG. 6 illustrates a network entity, according to an embodiment.

### DETAILED DESCRIPTION

The following description with reference to the accompanying drawings is provided to assist in a comprehensive understanding of the disclosure. It includes various specific details to assist in that understanding but these are to be regarded as merely examples. Accordingly, those of ordinary skill in the art will recognize that various changes and modifications of the various embodiments described herein can be made without departing from the scope and spirit of the disclosure. Descriptions of well-known functions and constructions may be omitted for the sake of clarity and conciseness.

Terms described below are terms defined in consideration of functions in the disclosure, which may vary according to intentions or customs of users and providers. Therefore, the definition should be made based on the content throughout this specification.

Some components are exaggerated, omitted, or schematically illustrated in the accompanying drawings. The size of each component does not fully reflect the actual size. In each drawing, the same reference numerals are given to the same or corresponding components.

Hereinafter, the disclosure will be described based on an approach of hardware. However, the disclosure may also be based on technology that uses both hardware and software, and thus, the disclosure may not exclude the perspective of software.

Herein, terms such as “comprise”, “include” and “contain” and variations thereof such as “comprising” and “comprises”, indicate “including but not limited to”, and are not intended to (and does not) exclude other features, elements, components, integers, steps, processes, operations, functions, characteristics, properties and/or groups thereof.

Throughout the description, the singular form, such as “a”, “an” and “the”, encompasses the plural unless the context otherwise requires. For example, reference to “an object” includes reference to one or more of such objects.

The skilled person will appreciate that the techniques described herein may be used in any suitable combination.

Certain examples of the disclosure provide one or more techniques for supporting UE member selection, such as for supporting AI/ML federated learning in a 3GPP 5G NR network. However, the skilled person will appreciate that the disclosure is not limited to these examples, and may be applied in any suitable system or standard, such as one or more existing and/or future generation wireless communication systems or standards, including any existing or future releases of the same standards specification, such as 3GPP 5G, 5G-advanced or 6G.

The functionality of the various network entities and other features disclosed herein may be applied to corresponding or equivalent entities or features in the same or any other suitable communication systems or standards. Corresponding or equivalent entities or features may be regarded as entities or features that perform the same or similar role, function or purpose within the network.

For example, the functionality of a base station or the like (e.g. eNB, gNB, NB, radio access network (RAN) node, access point, wireless point, transmission/reception point, central unit, distributed unit, radio unit, remote radio head, etc.) in the examples below may be applied to any other suitable type of entity performing RAN functions, and the functionality of a UE or the like (e.g. electronic device, user device, mobile station, subscriber station, customer premises equipment, terminal, remote terminal, wireless terminal, vehicle terminal, etc.) in the examples below may be applied to any other suitable type of device.

A particular network entity may be implemented as a network element on a dedicated hardware, as a software instance running on a dedicated hardware, and/or as a virtualized function instantiated on an appropriate platform, e.g. on a cloud infrastructure.

The disclosure is not limited to the specific examples disclosed herein. For example:

The techniques disclosed herein are not limited to 3GPP 5G.

One or more entities in the examples disclosed herein may be replaced with one or more alternative entities performing equivalent or corresponding functions, processes or operations.

One or more of the messages in the examples disclosed herein may be replaced with one or more alternative messages, signals or other type of information carriers that communicate equivalent or corresponding information.

One or more further elements or entities may be added to the examples disclosed herein.

One or more non-essential elements or entities may be omitted in certain examples.

The functions, processes or operations of a particular entity in one example may be divided between two or more separate entities in an alternative example.

The functions, processes or operations of two or more separate entities in one example may be performed by a single entity in an alternative example.

Information carried by a particular message in one example may be carried by two or more separate messages in an alternative example.

Information carried by two or more separate messages in one example may be carried by a single message in an alternative example.

The order in which operations are performed and/or the order in which messages are transmitted may be modified, if possible, in alternative examples.

Embodiments of the disclosure may be provided in the form of an apparatus/device/network entity configured to perform one or more defined network functions and/or a method therefor. Embodiments of the disclosure may be provided in the form of a system (e.g. network or wireless communication system) comprising one or more such apparatuses/devices/network entities, and/or a method therefor.

To support member UE selection assistance functionality, such as when using E2E data volume transfer time analytics as one of the filtering criteria for member UE selection, the disclosure uses one or more new parameters and/or items of information. The parameters/information include one or more of the following:

Information relating to data transmissions, including a target number of repeating data transmission and/or a target time interval between data transmissions.

Information relating to QoS requirements of a service, including 5Q1 and/or QoS characteristics.

Information relating to data volume, including an expected data volume, an observed data volume and/or a measured data volume. The expected data volume may be an expected data volume to be transferred between the UE and the AF, from the UE to the AF, and/or from the AF to the UE, and/or an expected roundtrip/UL/DL data volume. The observed/measured data volume may be an observed/measured data volume transferred between the UE and the AF, from the UE to the AF, and/or from the AF to the UE, and/or an observed/measured roundtrip/UL/DL data volume.

A request for geographical distribution of the UEs, including one or more AoIs.

The new parameters may be included in any suitable message between any suitable network entities, such as the AF request of the Member UE selection assistance subscribe service operation. For example, the parameters may be included in Nnef_MemberUESelectionAssistance_Subscribe as a part of the Input, Optional: specific parameters depending on the Member UE filtering criteria, as specified in clause 5.2.6.32.2 of 3GPP TS 23.502.

The parameters may be considered as UE filtering information of corresponding Member UE filtering criteria (e.g., QoS, E2E data volume transfer time, UE historical location, UE current location, UE separation distance, etc.). existing member UE filtering criteria are specified in Table 4.15.13.2-1 of 3GPP TS 23.502.

By indicating the new parameters/information, such as to the NEF by the AF, the NEF is able to include the corresponding parameters/information into the request or subscription to the NWDAF. Therefore, the NWDAF is able to derive the analytics outputs to support the member UE selection assistance based on the request of an NEF and/or AF.

To assist the AF with updating/optimizing the filtering criteria of member UE selection, the disclosure provides information relating to one or more time windows and/or one or more time points. For example, the time windows/time points may correspond to existing specific value measurements per UE filtering criteria and/or a number of UEs that cannot fulfil the specific filtering criterion. The information may include a number of time windows/time points within which there are UEs that cannot fulfil a specific filtering criterion.

The information relating to time windows/time points may be included in any suitable message between any suitable network entities, such as being provided by the NEF to the AF via Nnef_MemberUESelectionAssistance_Notify service operation.

Based on the above information, and possibly also any other suitable information (e.g. existing/legacy information), the AF may optimize the filtering criteria, such as considering the condition of the UEs and/or the network, as well as the service requirements of the application operation (e.g. AI/ML-based service, federated learning services). Therefore, the AF is able to maintain and improve the service quality and experience.

As described above, in the prior art, the data volume UL/DL and a request for geographical distribution (e.g. AoIs) of the UEs are requested as input parameters to support the NWDAF to derive the E2E data volume transfer time analytics for supporting services (e.g. AI/ML service, federated learning services, etc.). Therefore, in the disclosure, these parameters may be provided to the NWDAF by the service consumer (e.g. NEF), such as via Nnwdaf_AnalyticsSubscription_Subscribe service and/or Nnwdaf_AnalyticsInfo_Request service.

The NWDAF may consider the data volume UL/DL when deriving the E2E data volume transfer time analytics.

The data volume UL/DL may include the (approximate) expected, estimated, measured and/or observed size of the (potential) AI/ML related traffic (to be) transferred between any suitable network entities, such as between the UE and the AF, between the AF and the RAN node, and/or between the RAN node and the UE.

The AI/ML related traffic may be of any suitable form, such as AI/ML model, AI/ML inference data and/or signaling related to AI/ML service operating.

For the UL data volume, the AI/ML related traffic may be transmitted from UE and/or RAN node/base station; in this case, the UL data volume in the consumer's request may be the data volume estimated by the AF based on its internal logic and knowledge of the AI/ML based services, etc.

As shown below in Table 1, if the consumer request the Geographical distribution of the UE(s), the NWDAF should provide the Geographical distribution of the corresponding target UEs. Therefore, the consumer is able to determine the number of UEs in each location/position. The location/position information may be of any suitable type, such as an area of interest (AoI), a cell, a tracking area (TA), etc. UEs in the same or similar location/position may experience similar network conditions, such as congestion level and/or load of the network. Accordingly, this parameter may help the consumer with determining the UEs that are suitable to participate in the AI/ML operation.

TABLE 1

| Information | Description |
|---|---|
| >Geographical distribution | If requested, a list of UEs per |
| of the UE(s) | location information. |

The Geographical distribution of the UE(s) is only available as output analytics when the reporting target is a group of UEs or a list of UE IDs (e.g. a list of subscription permanent Identifiers (SUPIs) and/or GPSIs). In this case, a request for geographical distribution of UEs may be indicated using any suitable message, such as in either Nnwdaf_AnalyticsSubscription_Subscribe service or Nnwdaf_AnalyticsInfo_Request service by the consumer. If the reporting target of the analytics is ‘any UE’ or a single UE, then if a request for Geographical distribution is indicated, such as in either Nnwdaf_AnalyticsSubscription_Subscribe service or Nnwdaf_AnalyticsInfo_Request service by the consumer, then the NWDAF is not able to provide the Geographical distribution of the UE(s).

As described in clause 6.18.1 of 3GPP TS 23.288, if a target number of repeating data transmissions or a target time interval between data transmissions is given, the E2E data volume transfer time can be provided as an average value of every data volume transfer time within the Analytics target period.

As described above, the QoS requirements may be mandatory filter information of the E2E data volume transfer time analytics, which should be provided by the consumer via the request or subscription, such as by the NEF if the NEF is the consumer of the NWDAF analytics. However, when the NEF is the consumer of the E2E data volume transfer time analytics, the NEF may not have prior knowledge of the target number of repeating data transmission or target time interval or the QoS requirements (e.g. 5Q1, QOS Characteristics). Therefore, in the prior art, the NEF is unable to include the target number of repeating data transmission or target time interval or the QoS requirements in the subscription or the request to the NWDAF. In this case, the NWDAF cannot use the QoS requirements as analytics filter information, i.e. for analytics outputs reporting.

The consumer of the E2E data volume transfer time analytics may be AF or NEF, as specified in 3GPP TS 23.288. In the disclosure, the consumer of the analytics (e.g. NEF or AF) may indicate certain information to the NWDAF, such as one or more of data volume UL/DL/roundtrip (e.g. expected, observed and/or measured), a request for geographical distribution (e.g. AoIs) of the UEs, QoS requirements, target number of repeating data transmission, and target time interval between data transmissions. The information may be indicated, for example, via either Nnwdaf_AnalyticsSubscription_Subscribe service or Nnwdaf_AnalyticsInfo_Request service. In certain examples, the request for geographical distribution of the UEs may be indicated by the consumer only if the target of reporting is a group of UEs and/or a list of UE IDs (e.g. a list of SUPIs and/or GPSIs) and/or if the output analytics are associated with and/or applies to a group of UEs and/or a list of UE IDs.

The consumer of the E2E data volume transfer time analytics may be NEF. Based on the existing procedures in the current specification, the NEF may not know the data volume UL/DL/roundtrip (expected, observed and/or measured), QoS requirements, the target number of repeating data transmissions, the target time interval between data transmissions, and/or that a request for geographical distribution (e.g. AoIs) of the UEs is made. Therefore, the NEF may not be able to provide the above information, such as in either Nnwdaf_AnalyticsSubscription_Subscribe service or Nnwdaf_AnalyticsInfo_Request service operations. The NEF collects data for member UE selection assistance functionality based on AF request. The NEF may not have any prior knowledge of the service (e.g. AI/ML or federated learning service), such as if the member UE selection is the initial selection for a service, not an update of the member UE selection.

Therefore, the disclosure provides that the AF may inform the NEF of certain information, such as one or more of data volume UL/DL/roundtrip (e.g. expected, observed and/or measured), a request for geographical distribution (e.g. AoIs) of the UEs, QoS requirements, target number of repeating data transmission, and target time interval between data transmissions. For example, the information may be included in the Nnef_MemberUESelectionAssistance_Subscribe service operation from AF to NEF, such as along with or as part of the E2E data volume transfer time filtering criterion.

To support certain analytics (e.g. E2E data volume transfer time analytics) for supporting certain operations (e.g. AI/ML services or a federated learning operation), certain examples of the disclosure provide on or more of the following items of information:
Information relating to data transmissions, including a target number of repeating data transmission and/or a target time interval between data transmissions.
Information relating to QoS requirements of a service. The QoS requirements may include, for example, 5QI and/or QoS Characteristics.
Information relating to data volume, including an expected data volume, an observed data volume and/or a measured data volume. The expected data volume may be an expected data volume to be transferred between the UE and the AF, from the UE to the AF, and/or from the AF to the UE, and/or an expected roundtrip/UL/DL data volume. The observed/measured data volume may be an observed/measured data volume transferred between the UE and the AF, from the UE to the AF, and/or from the AF to the UE, and/or an observed/measured roundtrip/UL/DL data volume.
A request for geographical distribution of the UEs, including one or more AoIs.

Some or all of the above information may be indicated in any suitable messages between any suitable network entities. For example, the information may be provided by an analytics (e.g. E2E data volume transfer time analytics) consumer (e.g. NEF and/or AF) to NWDAF in the Nnwdaf_AnalyticsSubscription_Subscribe and/or Nnwdaf_AnalyticsInfo_Request messages. When NEF is the analytics consumer, the information may be provided by AF to NEF in the Nnef_MemberUESelectionAssistance_Subscribe request message, such as part of the UE filtering information/specific parameters associated with Member UE filtering criteria.

The Member UE filtering criteria may include one or more of the UE filtering criteria defined in Table 4.15.13.2-1 of TS 23.502, such as QoS, E2E data volume transfer time, UE historical location, UE current location, UE separation distance, etc.

The request for geographical distribution of UEs may be indicated by the AF to the NEF, such as via Nnef_MemberUESelectionAssistance_Subscribe request service. If the NEF receives the request, such as in the subscription request service, the NEF may include the request to the NWDAF. The NEF may include the request for UEs geographical distribution to the NWDAF only if the target of analytics reporting is a group of UEs and/or a list of UE IDs (e.g. SUPIs and/or GPSIs) and/or if the output analytics applies to a group of UEs and/or a list of UE IDs (e.g. SUPIs and/or GPSIs).

The request for geographical distribution of UEs and (expected) data volume/size of expected data/specific data volume may be associated with E2E data volume transfer time filtering criteria. If the AF include the E2E data volume transfer time filtering criteria in the Nnef_MemberUESelectionAssistance_Subscribe service operation, the AF may include the request for geographical distribution of UEs and (expected) data volume/size of expected data/specific data volume, the target number of repeating data transmission, the target time interval, and/or the QoS requirements (e.g. 5QI, QOS Characteristics) into Nnef_MemberUESelectionAssistance_Subscribe service operation.

To clarify how to indicate the new parameter(s) from AF and NEF, and how the NEF will use the new parameter(s) associated with different analytics and inform the NWDAF of the corresponding parameter(s), one or more E2E data volume transfer time Member UE filtering criteria (for example, one or more existing criteria) may be extended (and/or replaced) with one or more of the new parameters, as shown below in Table 2.

The E2E data volume transfer time is described in the current specification as follows: Indicate the target end-to-end data volume transfer time that refers to a time for completing the transmission of a specific data volume between UE and AF, e.g. the average and variance of End-to-end data volume transfer time.

The specific data volume between and AF may be: the expected data volume to be transferred between the UE and the AF, from the UE to the AF, and/or from the AF to the UE, and/or the roundtrip/UL/DL data volume; and/or the observed/measured data volume transferred between the UE and the AF, from the UE to the AF, and/or from the AF to the UE, and/or the roundtrip/UL/DL data volume.

The AF may indicate the request for geographical distribution (e.g. the AoIs) of the UEs, and the NEF may include the request for geographical distribution (e.g. the AoIs) of the UEs to the NWDAF to derive the E2E data volume transfer time analytics. Therefore, the target E2E data volume transfer time (e.g. the average and/or variance of E2E data volume transfer time) may also be associates with the geographical distribution (i.e. the AoIs) of the UEs.

The data volume transfer time may be derived by considering the target number of repeating data transmissions and/or the target time interval between data transmissions within the analytics target period.

The target repetition number of data transmissions or a target time interval between data transmissions may be given within the E2E data volume transfer time as part of the parameters associated with the E2E data volume transfer time member UE filtering criterion. The NEF may inform the above parameter to the NWDAF. If it is given, the E2E data volume transfer time may be provided, such as an average value of the data volume transfer time considering the target repetition number of data transmissions or a target time interval between data transmissions within the analytics target period by the NWDAF.

The NEF may also inform the NWDAF of using QoS requirements (e.g. 5Q1, QoS Characteristics) as filter information of E2E data volume transfer time analytics, when the NEF deploys the E2E data volume transfer time as one of the Member UE filtering criteria.

When deploying the E2E data volume transfer time member UE filtering criterion, the UE filtering information may include the E2E data volume transfer time UL and DL. Therefore, the NEF may use the target E2E data volume transfer time UL and DL to select the UEs that can fulfil this filtering criterion.

TABLE 2

| Member | | | |
|---|---|---|---|
| UE | Description of filtering | | Detailed |
| filtering | criteria for member | | description |
| criteria | UEs selected by NEF | UE filtering information | clause |
| End-to- | Indicate the target end- | NF service: | 4.15.13.6 |
| end data | to-end data volume | Nnwdaf_AnalyticsSubscription/ | |
| volume | transfer time that refers | Nnwdaf_AnalyticsInfo | |
| transfer | to a time for completing | Filter: Target = GPSI(s) or | |
| time | the transmission of a | SUPI(s), expected/observed/ | |
| | specific data volume | measured data volume, QoS | |
| | between UE and AF, | requirements, the target | |
| | e.g. the average and | number of repeating data | |
| | variance of End-to-End | transmission or target time | |
| | data volume transfer | interval, target number of | |
| | time | data transmission | |
| | Indicate the target end- | repetitions or target time | |
| | to-end data volume | interval | |
| | transfer time that | Analytics ID: E2E data volume | |
| | refers to a time for | transfer time | |
| | completing the | | |
| | transmission of the | | |
| | expected/observed/ | | |
| | measured data volume | | |
| | between UE and AF | | |
| | that might be indicated | | |
| | by the AF, e.g. the | | |
| | average and variance | | |
| | of End-to-End data | | |
| | volume transfer time. | | |
| | The transfer time is | | |
| | associated to | | |
| | Geographical | | |
| | distribution of the | | |
| | UE(s), if the request for | | |
| | geographical | | |
| | distribution (i.e. the | | |
| | Aols) of the UEs is | | |
| | included in the AF | | |
| | request. And the | | |
| | Geographical | | |
| | distribution of the | | |
| | UE(s) provided by the | | |
| | E2E transfer time | | |
| | analytics will be used | | |
| | to by the NEF to select | | |
| | candidate UEs. | | |
| | The data volume | | |
| | transfer time might be | | |
| | derived by considering | | |
| | the target number of | | |
| | repeating data | | |
| | transmission or target | | |
| | time interval within the | | |
| | Analytics target | | |
| | period. | | |

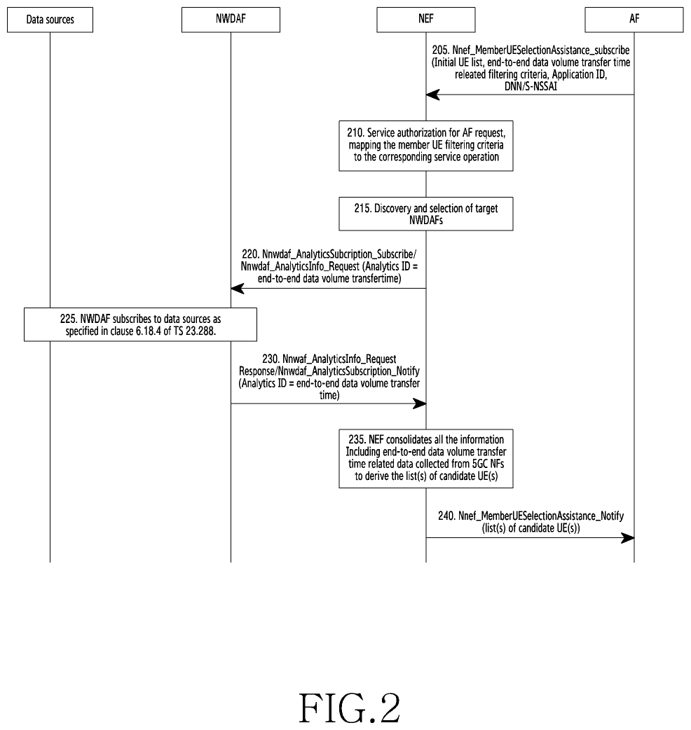

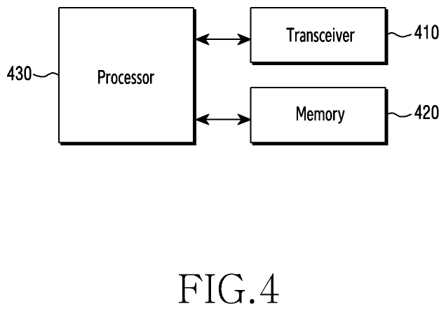

FIG. 2 illustrates a modification to FIG. 4.15.13.6.2-1 of 3GPP TS 23.502 assistance to member UE selection for end-to-end data volume transfer time related filtering criteria, according to an embodiment.

Referring to FIG. 2, procedures described herein for E2E data volume transfer time related member UE filtering criteria may operate according to 3GPP TS 23.502, clause 4.15.13.6, modified as indicated below by bold and underline.

The E2E data volume transfer time filtering criteria may be expressed as an average and/or variance; the E2E data volume transfer time may be for a specific data volume between UE and AF; the data volume indicated by the AF may be associated with the average and/or the variance of the end-to-end data volume transfer time in this filtering criterion.

### 4.15.13.6.1 General

An AF may invoke Nnef_MemberUESelectionAssistance_Subscribe service operation with end-to-end data volume transfer time related filtering criteria for receiving a list of UEs that fulfil the filtering criteria.
In addition to the mandatory parameters, the AF may also include in the request:
   End-to-end data volume transfer time filtering criteria: this may include the average end-to-end data volume transfer time for a specific data volume between UE and AF and/or the variance of the end-to-end data volume transfer time.
   An Area of Interest: location area of the candidate UEs.
   Time windows for selecting the candidate UEs: start time and stop time.
   expected data volume to be transferred between the UE and the AF or from the UE to the AF or from the AF to the UE, the roundtrip/UL/DL data volume; or the observed/measured data volume transferred between the UE and the AF or from the UE to the AF or from the AF to the UE, the roundtrip/UL/DL data volume. The Data Volume may be associated to the average and/or the variance of the end-to-end data volume transfer time in the End-to-end data volume transfer time filtering criteria. The expected, observed or measured data volume from UE to AF and/or from AF to UE of which the end-to-end data volume transfer time to be derived.
   the target number of repeating data transmission or target time interval/the target number of data transmission repetitions or target time interval.
   A request for geographical distribution of UEs.
   QoS requirements (e.g. 5Q1, QoS Characteristics).

### 4.15.13.6.2 Member UE Selection Assistance with End-to-End Data Volume Transfer Time Related Filtering Criteria

Referring to FIG. 2, in step 205, the AF subscribes to the member UE selection assistance functionality by invoking Nnef_MemberUESelectionAssistance_subscribe request including the Application ID, DNN/S NSSAI, AoI, and the end-to-end data volume transfer time related filtering criteria including the average end-to-end data volume transfer time and/or the variance of the transfer time, the target number of repeating data transmission or target time interval, expected/observed/measured Data Volume UL/DL/Roundtrip, request for geographical distribution (i.e. the AoIs) of the UEs. QoS requirements (e.g. 5Q1, QoS Characteristics), the expected, observed or measured Data Volume UL/DL between AF and UE, the target number of data transmission repetitions or target time interval, request for geographical distribution (i.e. the AoIs) of the UEs.
In step 210, the NEF verifies the authorization of the AF Request and identifies which information needs to be collected and executed based on the end-to-end data volume transfer time related filtering criteria provided by the AF.
In step 215, when the S-NSSAI/DNN are not included in the request from the AF, the NEF derives the S-NSSAI and DNN to which this Application has access. NEF discovers and selects the NWDAF(s) by invoking Nudm_UECM_Get or Nnrf_NFDiscovery_Request including Analytics ID=E2E data volume transfer time, AoI, S-NSSAI, etc.
In step 220, the NEF sends an Analytics request/subscribe to NWDAF by invoking Nnwdaf_AnalyticsSubscription_Subscribe Nnwdaf_AnalyticsInfo_Request including Analytics ID=E2E data volume transfer time, Application ID, DNN, S-NSSAI, AoI, and target UEs based on the initial UE list obtained from the AF, and the parameters associated to End-to-end data volume transfer time filtering criterion or E2E data volume transfer time analytics, i.e. the target number of repeating data transmission or target time interval. expected/observed/measured Data Volume UL/DL/Roundtrip, request for geographical distribution (i.e. the AoIs) of the UEs, QoS requirements (e.g. 5Q1, QoS Characteristics), the target number of data transmission repetitions or target time interval, the expected, observed or measured Data Volume UL/DL, request for geographical distribution (i.e. the AoIs) of the UEs, etc.
In step 225, the NWDAF collects data from multiple sources for end-to-end data volume transfer time analytics as specified in clause 6.18.2 of TS 23.288.
In step 230, the NWDAF provides the required output analytics to the consumer NF as specified in clause 6.18.4 of TS 23.288 by means of either Nnwdaf_AnalyticsInfo_Request response or Nnwdaf_AnalyticsSubscription_Notify, depending on the service used in step 4.
In step 235, based on the analytics received from the NWDAF, the NEF consolidates results and derives the list(s) of candidate UE(s) that fulfil the filtering criteria requested by the AF. The NEF may use the average end-to-end data volume transfer time of the specific/expected/measured/observed volumes of UL/DL data and/or the variance to derive the list(s) of candidate UEs and/or the Geographical distribution of the UE(s) that meet the requirements from the AF.
In step 240, the NEF sends a Nnef_MemberUESelectionAssistance_Notify request to the AF including the list(s) of candidate UE(s) and additional information.

Corresponding explanations of the disclosed parameters in the AF member UE selection assistance request may be defined based on the following modification of clause 6.18 of 3GPP TS 23.288 to indicate to the NWDAF how to deploy/use these parameters for analytics outputs generations or reporting.

### 6.18 End-to-End Data Volume Transfer Time Analytics

### 6.18.1 General

Clause 6.18 describes how NWDAF can provide E2E data volume transfer time analytics, in the form of statistics or predictions or both, to a service consumer. NWDAF collects E2E data volume transfer time related input data from 5GC NFs, OAM and AF. The consumer can either subscribe to analytics notifications (i.e. a Subscribe-Notify model) or request a single notification (i.e. a Request-Response model).
The E2E data volume transfer time refers to a time delay for completing the transmission of a specific data volume from UE to AF, or from AF to UE. One or more specific data volume might be indicated by the consumer, i.e. the NEF. The data volume might be the expected data volume to be transferred between the UE and the AF or from the UE to the AF or from the AF to the UE, the roundtrip/UL/DL data volume; or the observed/measured data volume transferred between the UE and the AF or from the UE to the AF or from the AF to the UE, the roundtrip/UL/DL data volume. The NWDAF may use the corresponding data volume as reference to collect the relevant input data, i.e. for the input parameters in Table 6.18.2-1/-2/-3, the service data might be associated to the indicated data volume or a piece of data/service/traffic has the similar data volume. For example, in Table 6.18.2-3 Transmitted UL/DL data volume are the same/similar/close to/approximate to the data volume indicated by the consumer, and the UL/DL transmission time duration are associated to the Transmitted UL/DL data volume. And the NWDAF may derive the corresponding E2E data volume transfer time for the data volume provided by the NEF. The NWDAF can derive the outputs that associated to the data volume that is the same/similar/close to/approximate to the data volume indicated for better support of AIML-based services. The data volume might be the expected data volume to be transferred between the UE and AF of an AI/ML-based service, or the observed or measured data volume transferred between the UE and AF based on consumer's preliminary knowledge. The NWDAF uses the data volume indicated by the consumer as a reference to collect the input data for deriving the statistics and prediction of the end-to-end data volume transfer time. If a target number of repeating data transmissions or a target time interval between data transmissions is given, the E2E data volume transfer time can be provided as an average value of every data volume transfer time within the Analytics target period. The E2E data volume transfer time analytics may be used to assist an AF hosting AI/ML-based services, e.g. for member selection of federated learning.
The E2E data volume transfer time analytics may be provided as defined in clause 6.18.3 for a UE individually or a list of UEs.

### Reuse the Information Associated to Other Filtering Criteria or Procedures/Combine the Information of Different Filtering Criteria

Alternatively, for the data volume, QoS requirements, the request for geographical distribution (i.e. the AoIs) of the UEs, the NEF may store and apply the data volume and QoS requirements of a service the NEF receives in other procedures for the same service, or based on the information within other filtering criteria for member UE selection provided by the AF.

For example, the NEF may store the data volume and/or the QoS requirements of a service receives during Setting up/update an AF session with required QoS procedure, Setting up/update Multi-member AF session with required QoS, Negotiations for planned data transfer with QoS requirements etc. The NEF may link the previously received data volume and/or the QoS requirements of a service (i.e. AIML service) to the newly received Nnef_MemberUESelectionAssistance_Subscribe request. Then, the NEF will include the data volume into the request or the subscription to the NWDAF to obtain the analytics, i.e. the E2E data volume transfer time analytics. The NEF may link the previously received data volume to the Nnef_MemberUESelectionAssistance_Subscribe request by matching the IDs associated to/indicated by the different procedure, i.e. by matching the application IDs. If the ID that links to the previously received data volume and/or QoS requirements is the same as that in the Nnef_MemberUESelectionAssistance_Subscribe, the NEF can determine that the previously received data volume and/or QoS requirement can be applied/linked to the received Nnef_MemberUESelectionAssistance_Subscribe request. And therefore, the NEF indicate the data volume and/or the QoS requirements to the NWDAF. The NWDAF may apply this data volume as a reference to collect input data and derive the output analytics. i.e. the NWDAF may collect the service data from multiple NFs that are associated to the data volume that is the same/similar to/approximate to/within a range/less than or equal to a threshold of the data volume received from the consumer. The NWDAF will use the QoS requirements as a one of the filters for output analytics reporting.

Alternatively, the NEF may consider the QoS requirements of the services (AIML or Federated learning services) in QoS Member UE filtering criteria as filter information of the NWDAF analytics for member UE selection. Then, the NEF informs the NWDAF of the corresponding QoS requirements to use as filter information.

The NEF may use the request for geographical distribution (i.e. the AoIs) of the UEs within other filtering criteria (i.e. UE current location, UE historical location, UE direction, UE separation distance, etc.) to support the E2E data volume transfer time filtering criterion.

The NEF may link/combine the filtering criteria in the same AF request for member UE selection (i.e. Nnef_MemberUESelectionAssistance_subscribe), or the NEF identifies whether the different member UE selection filtering criteria link to the same service (AIML services) based on Application ID, DNN or other information in the filter information.

During the member UE selection procedures, the AF may indicate the time window(s) for selecting the candidate UEs in the Nnef_MemberUESelectionAssistance_Subscribe request. The time window(s) for selecting the candidate UE(s) is used by the NEF when subscribing/requesting to NWDAF. The NEF maps the time window(s) for selecting the candidate UE(s) to the Analytics target period, which should be included in the Nnwdaf_AnalyticsSubscription_Subscribe or Nnwdaf_AnalyticsInfo_Request service operations.

Based on the AF request, the NEF collects and consolidate the required data to derive the UEs that fulfil the member UE selection filtering criteria. The NEF may also derive recommended time window(s) for the service operation, considering the validity period(s) of the analytics used for Member UE selection criteria. Within the recommended time window(s), the list(s) of candidate UE(s) can fulfil the Member UE filtering criteria. The recommended time window(s) are a subset of the time window(s) received from the AF. In different recommended time windows, the list of candidate UE(s) which fulfil the Member UE filtering criteria may be different.

The NEF may also indicate the specific value of the parameters that the NEF gathered for the Member UE filtering criteria per candidate UE and/or the number of UEs that cannot fulfil the filtering criterion (if there are multiple filtering criteria in the AF subscribe request). This information could be used by the NEF to revise the corresponding filtering criterion and therefore achieve the optimized service operation performance by considering the trade-off between the service quality, UE and network condition, the number of the UEs that are eligible to participate the service (i.e. AIML service), etc.

The UE and/or network conditions could be significantly different in different time windows or at different time points, such as due to load and traffic variation of the network, the services the UE and the network are operating, the variation of the control policies etc. There are some possibilities that only many UEs cannot fulfil certain filtering criterion within minimal time windows or time points. In this case, the AF may not need to decrease the threshold/the requirements of the filtering criterion to create more UEs that can satisfy the requirements of the service operation and decrease the service quality. Instead, the AF may determine to abandon some candidate time windows for operating the service. Therefore, it will be beneficial to inform the AF of the time windows or time points within/at which there are one or more UEs that cannot fulfil a specific filtering criterion, or the number of the time window within which there are one or more UEs that cannot fulfil a specific filtering criterion. However, in the prior art, the AF is unaware of the corresponding time window(s) or time points associated to the number of UEs that cannot fulfil this filtering criterion. The time window might be applied if the filtering criteria is related to analytics outputs, or if the filtering criteria is related to some real-time or historical data, i.e. QoS measurement, UE current location, UE historical location etc.

The NEF may indicate time window/time point or the number of time windows to the AF together with the existing specific value of the parameters and/or the number of the UE, i.e. via Nnef_MemberUESelectionAssistance_Notify or Nnef_MemberUESelectionAssistance_Notify service operation.

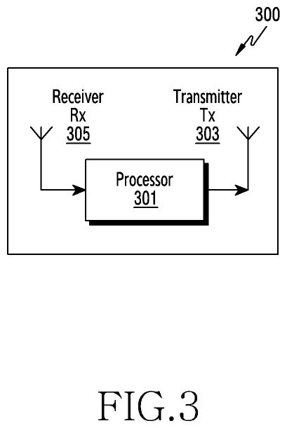

FIG. 3 illustrates an NE, according to an embodiment.

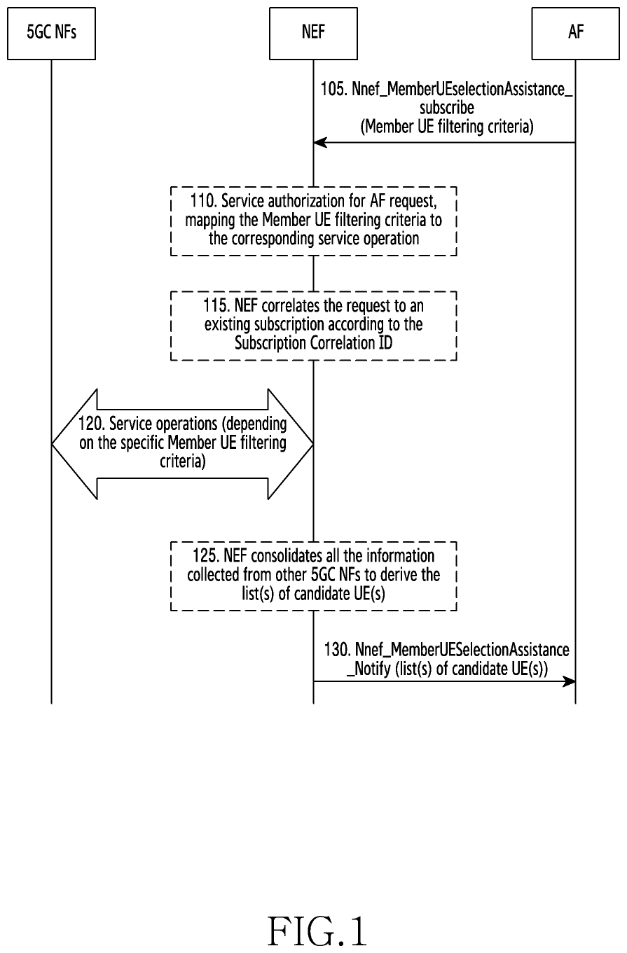

Referring to FIG. 3, a UE/network entity (e.g. NEF, AF, NF, NWDAF)/base station (e.g. eNB, gNB) in the examples of FIGS. 1 and 2 may comprise an entity of FIG. 3. One of ordinary skill will appreciate that an NE may be implemented, for example, as a network element on a dedicated hardware, as a software instance running on a dedicated hardware, and/or as a virtualized function instantiated on an appropriate platform, e.g. on a cloud infrastructure.

In FIG. 3, the entity 300 comprises a processor (or controller) 301, a transmitter 303 and a receiver 305. The receiver 305 is configured for receiving one or more messages from one or more other network entities, as described above. The transmitter 303 is configured for transmitting one or more messages to one or more other network entities, as described above. The processor 301 is configured for performing one or more operations, such as according to the operations as described above.

FIG. 4 illustrates a terminal (or a UE), according to an embodiment.

Referring to FIG. 4, the UE may include a transceiver 410, a memory 420, and a processor 430. The transceiver 410, the memory 420, and the processor 430 of the UE may operate according to a communication method of the UE described above. However, the components of the UE are not limited thereto. For example, the UE may include more or fewer components than those described above. In addition, the processor 430, the transceiver 410, and the memory 420 may be implemented as a single chip. Also, the processor 430 may include at least one processor.

The transceiver 410 collectively refers to a UE receiver and a UE transmitter, and may transmit/receive a signal to/from a base station or a network entity. The signal transmitted or received to or from the base station or a network entity may include control information and data. The transceiver 410 may include a RF transmitter for up-converting and amplifying a frequency of a transmitted signal, and a RF receiver for amplifying low-noise and down-converting a frequency of a received signal. However, this is only an example of the transceiver 410 and components of the transceiver 410 are not limited to the RF transmitter and the RF receiver.

The transceiver 410 may receive and output, to the processor 430, a signal through a wireless channel, and transmit a signal output from the processor 430 through the wireless channel.

The memory 420 may store a program and data required for operations of the UE. Also, the memory 420 may store control information or data included in a signal obtained by the UE. The memory 420 may be a storage medium, such as read-only memory (ROM), random access memory (RAM), a hard disk, a CD-ROM, and a DVD, or a combination of storage media.

The processor 430 may control a series of processes such that the UE operates as described above. For example, the transceiver 410 may receive a data signal including a control signal transmitted by the base station or the network entity, and the processor 430 may determine a result of receiving the control signal and the data signal transmitted by the base station or the network entity.

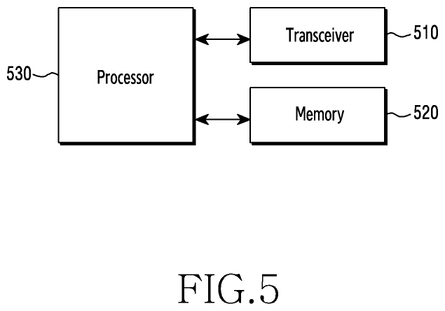

FIG. 5 illustrates a base station, according to embodiments of the disclosure.

Referring to FIG. 5, the base station according to an embodiment may include a transceiver 510, a memory 520, and a processor 530. The transceiver 510, the memory 520, and the processor 530 of the base station may operate according to a communication method of the base station described above. However, the components of the base station are not limited thereto. For example, the base station may include more or fewer components than those described above. In addition, the processor 530, the transceiver 510, and the memory 520 may be implemented as a single chip. The processor 530 may include at least one processor.

The transceiver 510 collectively refers to a base station receiver and a base station transmitter, and may transmit/receive a signal to/from a terminal or a network entity. The signal transmitted or received to or from the terminal or a network entity may include control information and data. The transceiver 510 may include a RF transmitter for up-converting and amplifying a frequency of a transmitted signal, and a RF receiver for amplifying low-noise and down-converting a frequency of a received signal. However, this is only an example of the transceiver 510 and components of the transceiver 510 are not limited to the RF transmitter and the RF receiver.

The transceiver 510 may receive and output, to the processor 530, a signal through a wireless channel, and transmit a signal output from the processor 530 through the wireless channel.

The memory 520 may store a program and data required for operations of the base station. The memory 520 may store control information or data included in a signal obtained by the base station. The memory 520 may be a storage medium, such as read-only memory (ROM), random access memory (RAM), a hard disk, a CD-ROM, and a DVD, or a combination of storage media.

The processor 530 may control a series of processes such that the base station operates as described above. For example, the transceiver 510 may receive a data signal including a control signal transmitted by the terminal, and the processor 530 may determine a result of receiving the control signal and the data signal transmitted by the terminal.

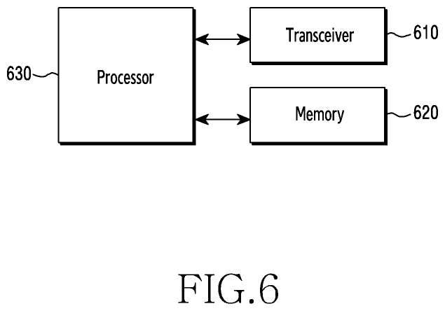

FIG. 6 illustrates an NE, according to an embodiment.

Referring to FIG. 6, the network entity according to an embodiment may include a transceiver 610, a memory 620, and a processor 630. The transceiver 610, the memory 620, and the processor 630 of the network entity may operate according to a communication method of the network entity described above. However, the components of the network entity are not limited thereto. For example, the network entity may include more or fewer components than those described above. In addition, the processor 630, the transceiver 610, and the memory 620 may be implemented as a single chip. The processor 630 may include at least one processor.

The transceiver 610 collectively refers to a network entity receiver and a network entity transmitter, and may transmit/receive a signal to/from a terminal or other network entity. The signal transmitted or received to or from the terminal or other network entity may include control information and data. The transceiver 610 may include a RF transmitter for up-converting and amplifying a frequency of a transmitted signal, and a RF receiver for amplifying low-noise and down-converting a frequency of a received signal. However, this is only an example of the transceiver 610 and components of the transceiver 610 are not limited to the RF transmitter and the RF receiver.

The transceiver 610 may receive and output, to the processor 630, a signal through a wireless channel, and transmit a signal output from the processor 630 through the wireless channel.

The memory 620 may store a program and data required for operations of the network entity. The memory 620 may store control information or data included in a signal obtained by the network entity. The memory 620 may be a storage medium, such as read-only memory (ROM), random access memory (RAM), a hard disk, a CD-ROM, and a DVD, or a combination of storage media.

The processor 630 may control a series of processes such that the network entity operates as described above. For example, the transceiver 610 may receive a data signal including a control signal transmitted by the terminal, and the processor 630 may determine a result of receiving the control signal and the data signal transmitted by the terminal.

The techniques described herein may be implemented using any suitably configured apparatus and/or system. Such an apparatus and/or system may be configured to perform a method according to an embodiment disclosed herein. Such an apparatus may comprise one or more elements, such as one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). The one or more elements may be implemented in the form of hardware, software, or any combination of hardware and software.

It will be appreciated that examples of the disclosure may be implemented in the form of hardware, software or any combination of hardware and software. Any such software may be stored in the form of volatile or non-volatile storage, such as a storage device like a read only memory (ROM), whether erasable or rewritable or not, or in the form of memory such as a random access memory (RAM), memory chips, device or integrated circuits or on an optically or magnetically readable medium such as, for example, a CD, DVD, magnetic disk or magnetic tape or the like.

It will be appreciated that the storage devices and storage media are embodiments of machine-readable storage that are suitable for storing a program or programs comprising instructions that, when executed, implement certain examples of the disclosure. Accordingly, certain examples provide a program comprising code for implementing a method, apparatus or system according to any example, embodiment, aspect and/or claim disclosed herein, and/or a machine-readable storage storing such a program. Such programs may be conveyed electronically via any medium, such as a communication signal carried over a wired or wireless connection.

While the disclosure has been described with reference to various embodiments, various changes may be made without departing from the spirit and the scope of the present disclosure, which is defined, not by the detailed description and embodiments, but by the appended claims and their equivalents.

What is claimed is:

1. A method performed by a network exposure function (NEF) entity in a wireless communication system, the method comprising:
receiving, from an application function (AF) entity, a first message for subscribing to a member user equipment (UE) selection assistance service, the first message including filtering criteria associated with an end-to-end data volume transmission time;
identifying information to be collected based on the filtering criteria;
transmitting, to a network data analytics function (NWDAF) entity, a second message for requesting data analytics for the end-to-end data volume transmission time;
receiving, from the NWDAF entity, a third message including the data analytics; and
transmitting, to the AF entity, a fourth message for notifying the member UE selection assistance service.

2. The method of claim 1,
wherein the filtering criteria includes at least one of a data volume, a target number of data transmission repetition, target time interval between data transmission, or request for geographical distribution of a UE.

3. The method of claim 1,
wherein the fourth message comprises a list of one or more UEs that fulfill the filtering criteria based on the data analytics.

4. The method of claim 2,
wherein the data volume is expected or observed data volume between the AF entity and the UE,
wherein the data volume is used as a reference data volume,
wherein the data analytics is associated with the information collected based on the reference data volume.

5. A method performed by an application function (AF) entity in a wireless communication system, the method comprising:
transmitting, a network exposure function (NEF) entity, a first message for subscribing to a member user equipment (UE) selection assistance service, the first message including filtering criteria associated with an end-to-end data volume transmission time; and
receiving, from the NEF entity, a second message including data analytics for the end-to-end data volume transmission time,
wherein the data analytics comprises a list of one or more UEs that fulfill the filtering criteria.

6. The method of claim 5,
wherein the filtering criteria includes at least one of a data volume, a target number of data transmission repetition, target time interval between data transmission, or request for geographical distribution of a UE.

7. The method of claim 6,
wherein the data volume is expected or observed data volume between the AF entity and the UE,
wherein the data volume is used as a reference data volume,
wherein the data analytics is associated with the information collected based on the reference data volume.

8. A network exposure function (NEF) entity in a wireless communication system, the NEF entity comprising:
a transceiver, and
a controller coupled with the transceiver and configured to:
receive, from an application function (AF) entity, a first message for subscribing to a member user equipment (UE) selection assistance service, the first message including filtering criteria associated with an end-to-end data volume transmission time,
identify information to be collected based on the filtering criteria,
transmit, to a network data analytics function (NWDAF) entity, a second message for requesting data analytics for the end-to-end data volume transmission time,
receive, from the NWDAF entity, a third message including the data analytics, and
transmit, to the AF entity, a fourth message for notifying the member UE selection assistance service.

9. The NEF entity of claim 8,
wherein the filtering criteria includes at least one of a data volume, a target number of data transmission repetition, target time interval between data transmission, or request for geographical distribution of a UE.

10. The NEF entity of claim 9,
wherein the fourth message comprises a list of one or more UEs that fulfill the filtering criteria based on the data analytics.

11. The NEF entity of claim 9,
wherein the data volume is expected or observed data volume between the AF entity and the UE,
wherein the data volume is used as a reference data volume,
wherein the data analytics is associated with the information collected based on the reference data volume.

12. An application function (AF) entity in a wireless communication system, the AF entity comprising:
a transceiver, and
a controller coupled with the transceiver and configured to:
transmit, a network exposure function (NEF) entity, a first message for subscribing to a member user equipment (UE) selection assistance service, the first message including filtering criteria associated with an end-to-end data volume transmission time,
receive, from the NEF entity, a second message including data analytics for the end-to-end data volume transmission time,
wherein the data analytics comprises a list of one or more UEs that fulfill the filtering criteria.

13. The AF entity of claim 12,
wherein the filtering criteria includes at least one of a data volume, a target number of data transmission repetition, target time interval between data transmission, or request for geographical distribution of a UE.

14. The AF entity of claim 13,
wherein the data volume is expected or observed data volume between the AF entity and the UE,
wherein the data volume is used as a reference data volume,
wherein the data analytics is associated with the information collected based on the reference data volume.
